(19) United States
(12) Patent Application Publication
(10) Pub. No.: US 2026/0119885 A1
(43) Pub. Date: Apr. 30, 2026

(54) DYNAMIC QUANTIZED TRANSFORMERS

(71) Applicant: INTUIT INC., Mountain View, CA (US)

(72) Inventors: Matan VETZLER, Givat Shmue'l (IL); Shai ARDAZI, Petach Tikva (IL); Kfir AHARON, Ness-Ziona (IL); Guy LEV, Givaataim (IL)

(21) Appl. No.: 18/934,058

(22) Filed: Oct. 31, 2024

(51) Int. Cl. G06N 3/09; G06N 3/0475; G06N 3/0495

(52) U.S. Cl. CPC G06N 3/09; G06N 3/0475; G06N 3/0495

(57) ABSTRACT

Aspects of the present disclosure relate to automated content generation. Embodiments include receiving a prompt from a user. Embodiments further include providing the prompt as an input to a classification model, wherein the classification model has been trained to generate outputs that indicate levels of quantization for a generative machine learning model when provided with input prompts. Embodiments further include receiving, based on the prompt, an output from the classification model indicating a given level of quantization. Embodiments further include providing the prompt as input to a given generative machine learning model based on the output, wherein the given generative machine learning model has been quantized according to the given level of quantization. Embodiments further include generating, via the given generative machine learning model, a response to the prompt.

### INTRODUCTION

Aspects of the present disclosure relate to techniques for automated content generation. In particular, techniques described herein involve optimizing the level of quantization used for a generative machine learning model in generating content based on the prompt used to request the content.

### BACKGROUND

Every year a growing number of people, businesses, and organizations around the world utilize generative machine learning technologies to automatically generate content. For example, a generative machine learning model may be used to generate answers to questions, responses to commands, summaries of content, images, unique literary works, and/or the like.

Content generation tasks performed by generative machine learning models may require an extensive amount of computational and memory resources. For example, a generative model such as a neural network may process an input through nodes of the neural network to generate an output, such as based on multiplying an input signal by weights that connect the nodes. A process known as quantization may be used to reduce the computational and memory resource cost associated with generative machine learning tasks. Quantization generally refers to a process used to reduce the bits in the weights (and, in some aspects, in activation values) of a machine learning model. As an example, if the weights of a machine learning model are sixty-four bits, quantization may be used to reduce each weight to thirty-two bits. The smaller weights may require significantly less memory to store and require significantly less computational power to process.

However, quantizing the weights can also reduce the performance of the generative model. For example, a model with quantized weights may be less precise because the number of bits is reduced. As a result, outputs generated by the quantized model may be more likely to contain errors, imperfections, and/or the like (e.g., when quantized, models may generate responses that are less relevant, answers that are less accurate, and/or the like). As a result, users and developers of generative machine learning systems may be forced to choose between efficiency and output quality.

Thus, there is a need in the art for improved techniques of automated content generation using generative machine learning models.

### BRIEF SUMMARY

Certain embodiments provide a method of automated content generation. The method generally includes: receiving a prompt from a user; providing the prompt as an input to a classification model, wherein the classification model has been trained to generate outputs that indicate levels of quantization for a generative machine learning model when provided with input prompts; receiving, based on the prompt, an output from the classification model indicating a given level of quantization; providing the prompt as input to a given generative machine learning model based on the output, wherein the given generative machine learning model has been quantized according to the given level of quantization; and generating, via the given generative machine learning model, a response to the prompt.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned method as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated content generation.

FIG. 2 depicts an additional example of computing components related to automated content generation.

FIG. 3 depicts an additional example of computing components related to automated content generation.

FIG. 4 depicts example operations related to automated content generation.

FIG. 5 depicts an example of a processing system for automated content generation.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated content generation.

According to certain embodiments, a user may submit a prompt (e.g., a natural language prompt) to a generative machine learning model system in order to receive generated content. The prompt may be provided to a classification model that is trained to generate outputs indicating levels of quantization when provided with prompts from users. The classification model may generate an output indicating a level of quantization for a generative machine learning model that will generate a response to the prompt. The prompt may then be dynamically routed to a generative machine learning model that has the level of quantization indicated in the output from the classification model. The generative machine learning model may then generate a response to the prompt.

Some embodiments provide that training data for the classification model may be generated based on providing a training prompt as input to a non-quantized generative model. The output from the non-quantized model may be used as a ground truth response. Outputs generated by quantized models in response to the training prompt may be compared to the ground truth response (e.g., based on a semantic similarity comparison involving embeddings). The training input may then be labeled based on the highest level of quantization that allowed for a response that matches the ground truth response (and if no response matches the ground truth response, the label may indicate that no amount of quantization is appropriate). For example, a machine learning model that has been quantized such that each weight is eight bits may generate a response that does not sufficiently match the ground truth response, whereas a machine learning model that has been quantized such that each weight is sixteen bits may generate a response that matches the ground truth response by a threshold amount. As a result, the training prompt may be given a label that indicates that sixteen bit quantization is appropriate for generating a response to the prompt. The classification model may then be trained through a supervised learning process based on the labeled training prompt.

Embodiments of the present disclosure provide numerous technical and practical effects and benefits. For example, by routing user prompts based on automatically predicting the maximum amount of quantization that is appropriate for generating a response to the prompt, techniques described herein allow for optimizing the accuracy and efficiency of generative machine learning systems. As a result, computational and memory resources are conserved while users receive high quality responses to prompts. In particular, quantization may be applied in generating various content items, while users may experience none of the quality-related tradeoffs associated with quantization. Thus, techniques described herein improve the technology of automated content generation by improving resource efficiency while ensuring a sufficient level of accuracy, and improve the functioning of the computer by reducing the amount of computing resources utilized to generate accurate content. Aspects of the present disclosure overcome technical challenges associated with existing quantization techniques by reducing or eliminating the accuracy issues that exist in such techniques through dynamic predictive routing of prompts to models with appropriate amounts of quantization for producing accurate results with minimal computing resource utilization.

### Example of Computing Components Related to Automated Content Generation

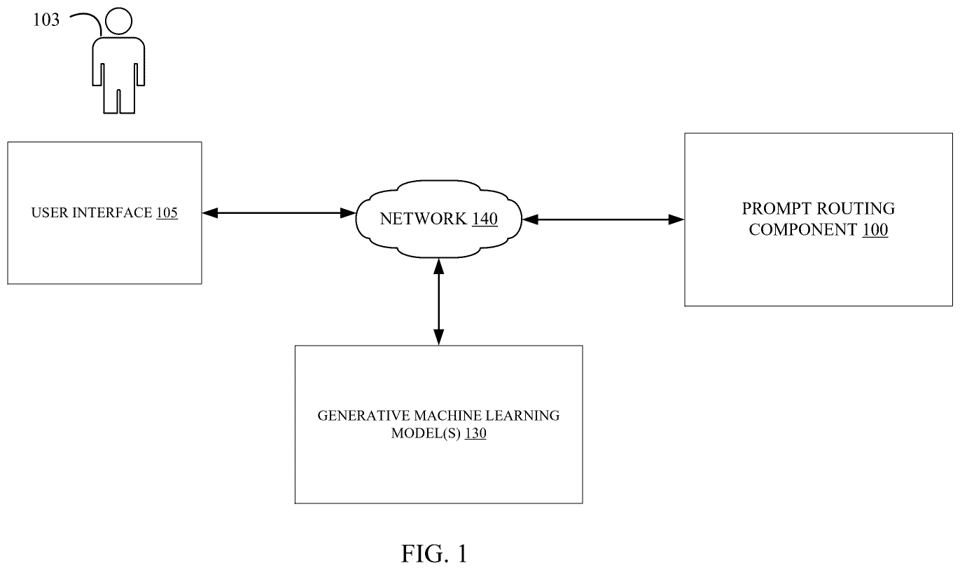

FIG. 1 depicts an example of computing components related to automated content generation.

A user 103 may interact with a generative machine learning model system via a user interface 105 associated with a computing device. The generative machine learning model system may, for example, comprise a software application that may be used to deliver content to the user 103. The generative machine learning model system may be used to generate content based on prompts submitted by the user 103 via the user interface 105. For example, the generative machine learning model system may be used to generate responses comprising text such as answers to questions, summaries of other forms of content, responses to commands, other forms of responses based on other content, and/or the like. Responses may be in forms other than text. For example, a response may comprise one or more images, videos, audio data, and/or the like.

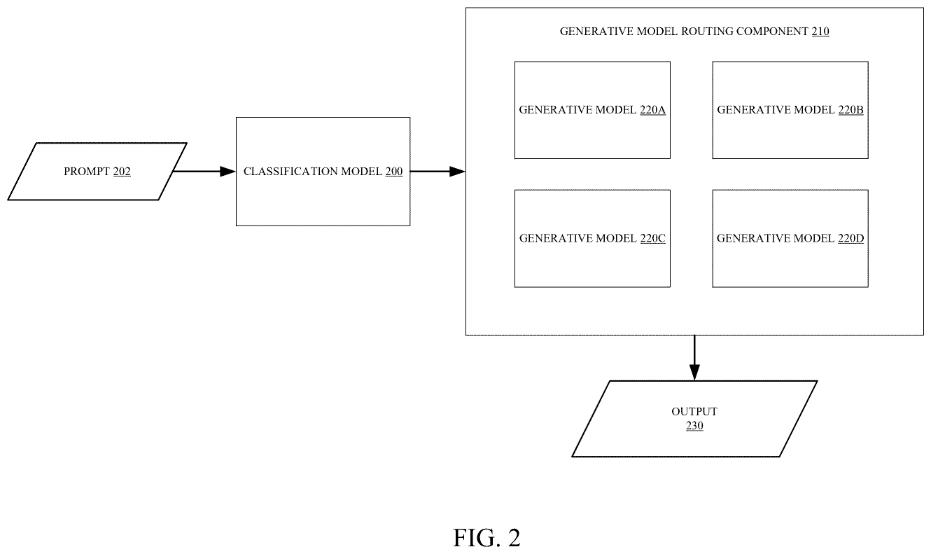

The generative machine learning model system may comprise a prompt routing component 100 that routes prompts to one or more generative machine learning models 130. As discussed in further detail below with respect to FIG. 2, the prompt routing component 100 may be used to route user prompts based on the highest level of quantization that is predicted to be appropriate for generating a response to the prompt. For example, simple prompts (e.g., prompts that request simple outputs, prompts that are simple for a model to process, and/or the like) may not require a high amount of precision to generate an appropriate response (e.g., a response that is accurate, relevant, and/or the like). As a result, simple prompts may be routed to a generative machine learning model 130 that has been highly quantized. By contrast, complex prompts (e.g., prompts that request complicated outputs, prompts that are complicated for the model to process, and/or the like) may require a high amount of precision to generate an appropriate response. Thus, complex prompts may be routed to a generative machine learning model 130 that is not as highly quantized (or, in some instances, a model that has not been quantized at all).

The computing device(s) associated with the user interface 105, the prompt routing component 100, and the generative machine learning models 130 may interact over network 140. Network 140 may be any connection over which data may be transmitted. In one example, network 140 is the Internet.

FIG. 2 depicts an additional example of computing components related to automated content generation. In particular, FIG. 2 depicts functionality that may be performed by the prompt routing component 100 and generative machine learning models 130 of FIG. 1.

A prompt 202 may be submitted by the user. The prompt 202 may comprise a natural language prompt, a selection of one or more options for content generation, and/or the like. When a generative machine learning model is provided with the prompt 202 as input, the generative machine learning model may generate a response to the prompt.

The prompt 202 may be provided as input to a classification model 200. The classification model 200 may generally be any type of model that is capable of generating an output indicating an appropriate level of quantization for generating a response to the prompt 202. In some embodiments, the classification model 200 may comprise a machine learning model, such as a neural network. In an example embodiment, the classification model 200 comprises a decoding-enhanced Bidirectional Encoder Representation from Transformer with disentangled attention (DeBERTa) model. In certain embodiments, the classification model 200 may comprise a tree-based machine learning model such as a gradient boosted tree, random forest, and/or the like. In some embodiments, the classification model 200 may comprise a Bayesian classifier, a regression model, a support vector machine, and/or the like.

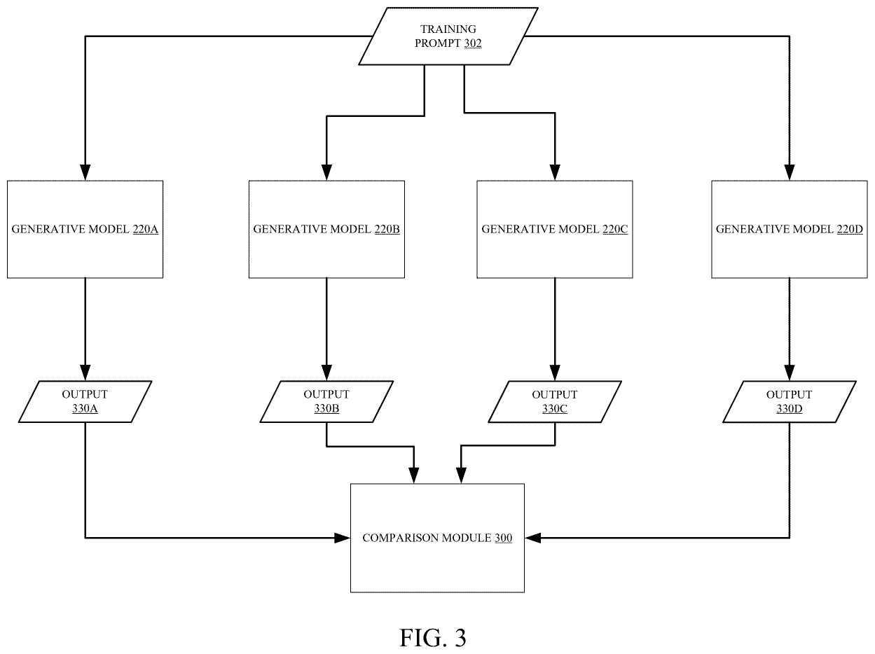

Some embodiments provide that the classification model 200 is trained to generate an output that indicates a generative model 220 to which the prompt 202 will be routed. The classification model 200 may be trained based on supervised, unsupervised or semi-supervised learning techniques. For example, the classification model 200 may be trained through a supervised learning process involving training data generated as described below with respect to FIG. 3.

Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model, such as based on validation data and test data, as is known in the art.

A supervised learning process for the classification model 200 may comprise providing a training prompt to the classification model 200. The training prompt may, for example, comprise a prompt that was historically provided to one or more generative machine learning models. The training prompt may further be associated with a label indicating a particular level of quantization (e.g., the highest level of quantization that resulted in an appropriate response for that training prompt during a training data generation process). The classification model 200 may generate an output that indicates a level of quantization. The output may be compared to the label, and one or more parameters of the classification model may be adjusted based on a variance between the label and the output.

Certain embodiments provide that the classification model 200 comprises an embedding model. An embedding generally refers to a vector representation of an entity that represents the entity as a vector in n-dimensional space such that similar entities are represented by vectors that are close to one another in the n-dimensional space. The embedding model may comprise a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating vector representations of entities (such as embedding representations) are possible.

In some embodiments, the classification model 200 may generate embeddings of user-provided prompts, and the embeddings may be compared (e.g., based on clustering techniques and/or semantic similarity algorithms) to labeled embeddings of prompts (e.g., based on labels applied to prompts as discussed below with respect to FIG. 3) to determine which prompts are most similar to the user-provided prompt. If the user-provided prompt is most similar to a group (e.g., an embedding cluster) or particular prompt associated with a particular level of quantization, an output may be generated that indicates the particular level of quantization. Embedding representations of prompts may be clustered using a clustering algorithm (e.g., a k-Means algorithm).

The output of the classification model 200, which indicates a particular level of quantization, may be provided to the generative model routing component 210. The generative model routing component 210 may comprise a computing component that is configured to route the prompt 202 to a generative model 220 based on the output of the classification model 200. For example, the generative model system may comprise four generative machine learning models 220 with varying levels of quantization.

The generative models 220 may be generally any type of machine learning model to which quantization may be applied. For example, the generative models 220 may be transformer-based models such as large language models (LLMs). In other embodiments, the generative models 220 may comprise long short-term memory (LSTM) models, convolutional neural networks, recurrent neural networks, vision models, and/or the like. In some embodiments, generative models 220 may include multiple “versions” of the same machine learning model with different levels of quantization. For example, all of generative models 220 may have a same type, architecture, number of layers, and/or the like. Generative model 220A may be a non-quantized version of a given generative machine learning model (e.g., the given generative model may be a model that is trained to perform a particular task). Generative model 220B may be a heavily quantized version of the given generative machine learning model (e.g., quantized using int4 quantization). Generative model 220C may be a moderately quantized version of the given generative machine learning model (e.g., quantized using int8 quantization). Generative model 220D may be a slightly quantized version of the given generative machine learning model (e.g., quantized using float16 quantization). These levels of quantization are intended as examples, and other levels of quantization and/or more/fewer generative models may be used.

In an example, the prompt 202 may be provided to the classification model 200. The classification model 200 may generate an output indicating a level of quantization based on the prompt 202. The indicated level of quantization may be int8 quantization. Based on this, the prompt 202 may be routed to generative model 220C, a version of the generative model that has been quantized using int8 quantization. As another example, the level of quantization indicated by the output from the classification model 200 may be no quantization. Based on this, the prompt 202 may be routed to generative model 220A, a non-quantized version of the generative model.

Once the prompt 202 is routed to a generative model 220, the generative model 220 may generate an output 230 based on the prompt 202. For example, the prompt 202 may comprise a question, a request for content, and/or the like. The output 230 may comprise an answer to the question, the requested content, and/or the like. The output 230 may be provided to the user, such as via a user interface.

FIG. 3 depicts an additional example of computing components related to automated content generation. In particular, FIG. 3 depicts functionality that may be used to generate labeled prompts for training data and/or clustering.

A training prompt 302 may be provided as input to generative model 220A, a non-quantized version of a given generative model. Based on the training prompt 302, generative model 220A may generate an output 330A. Because generative model 220A is non-quantized, and therefore more precise than the other models, output 330A may be considered a ground truth high-quality output. Other outputs may be compared to output 330A to determine a label for the training prompt 302.

The training prompt 302 may be provided to generative model 220B, a heavily quantized version of the given generative model (e.g., quantized using int4 quantization). Based on the training prompt 302, generative model 220B may generate an output 330B. Output 330A and output 330B may be provided to comparison module 300. Comparison model 300 may comprise a computing component that is configured to generate an indication of the similarity between two outputs. In some embodiments, comparison module 300 may use a text-based comparison technique such as n-grams (n-grams are generally groups of up to n consecutive words or characters, where n is a positive integer). For instance, n-grams of output 330A may be compared to n-grams of output 330B using a bilingual evaluation understudy (BLEU) algorithm, a recall-oriented understudy for gisting evaluation (ROUGE) algorithm, an edit distance algorithm, and/or the like. Certain embodiments provide that the comparison may comprise a semantic similarity comparison. For example, embedding representations may be created of output 330A and output 330B. The embedding representations may be compared using a semantic similarity algorithm (e.g., cosine similarity). In other embodiments, the comparison module 300 may comprise a machine learning model configured to compare two outputs and generate an indication of the similarity between the outputs (e.g., based on LLM-as-judge techniques). These comparison techniques are included as examples only, and other techniques for comparing the similarity of two outputs may be used.

Based on the indication of similarity generated by the comparison module 300, the training prompt 302 may be labeled. For example, if the similarity of output 330B and output 330A exceeds a threshold, training prompt 302 may be labeled to indicate that int4 quantization is appropriate for generating a response to the training prompt 302. In other words, if int4 quantization results in an output that is sufficiently similar to the output generated by a non-quantized model, int4 quantization is appropriate for generating a response to the prompt.

If the similarity between output 330B and output 330A does not meet the threshold, training prompt 302 may be provided as input to generative model 220C, which may generate output 330C in response. As described above, generative model 220C may be a model that has been quantized using int8 quantization, making generative model 220C more precise than generative model 220B, which may have been quantized using int4 quantization. If the similarity of output 330C and output 330A exceeds a threshold, training prompt 302 may be labeled to indicate that int8 quantization is appropriate for generating a response to the training prompt 302.

If the similarity between output 330C and output 330A does not meet the threshold, training prompt 302 may be provided as input to generative model 220D, which may generate output 330D in response. As described above, generative model 220D is a model that has been quantized using float16 quantization, making generative model 220D more precise than generative model 220C, which was quantized using int8 quantization. If the similarity of output 330D and output 330A exceeds a threshold, training prompt 302 may be labeled to indicate that float16 quantization is appropriate for generating a response to the training prompt 302.

If none of the outputs 330B-D meet the similarity threshold when compared to output 330A, training prompt 302 may be labeled to indicate that no quantization is appropriate for generating a response to the training prompt 302. In other words, if none of the quantized models were able to sufficiently match the non-quantized output, generating the response with a non-quantized model is appropriate.

Notably, by comparing the output from the non-quantized model to the output from the most highly quantized model first, techniques described herein avoid the need to generate an output using one or more less highly quantized models at all if the output from the most highly quantized model is sufficiently similar to the output from the non-quantized model. Thus, aspects of the present disclosure may involve working serially from the most highly quantized model to the least highly quantized model when generating outputs and comparing those outputs to the output from the non-quantized model, thereby improving efficiency and avoiding unnecessary computing resource utilization when generating training data.

Alternate embodiments provide that the training prompt 302 may be labeled manually. For example, the comparison may be made manually based on outputs of the various generative models 220.

As described above with respect to FIG. 2, the labeled training prompt 302 may be used as training data to train the classification model 200. In other embodiments, an embedding representation of the labeled training prompt 302 may be created and compared to embedding representations of user-provided prompts. If a user-provided prompt is determined to be similar to the training prompt 302 (or an embedding/embedding cluster associated with the training prompt 302), the user-provided prompt may be routed to a generative model with the level of quantization indicated in the label.

In some embodiments, user feedback may be received with respect to a generated output that is provided to a user. For example, the user feedback may comprise a natural language indication of the level of quality/relevance of the output (e.g., which may be processed according to natural language processing techniques as known in the art), a selection of a multiple choice answer regarding quality/relevance of an output, a user interaction or non-interaction with the output, and/or the like. Based on the user feedback, the classification model 200 may be retrained. For example, a user-provided prompt may be given a label indicating a higher level of quantization than was used to generate the response to the prompt (e.g., if int4 quantization was used, the label may indicate int8 quantization). In another example the user-provided prompt may be assigned a label by performing a process such as that described with respect to FIG. 3 (e.g., with the user-provided prompt being used in place of training prompt 302). The classification model 200 may be retrained based on this labeled user-provided prompt, the labeled user-provided prompt may be added to an embedding cluster associated with the indicated level of quantization, and/or the like.

### Example Operations Related to Automated Content Generation

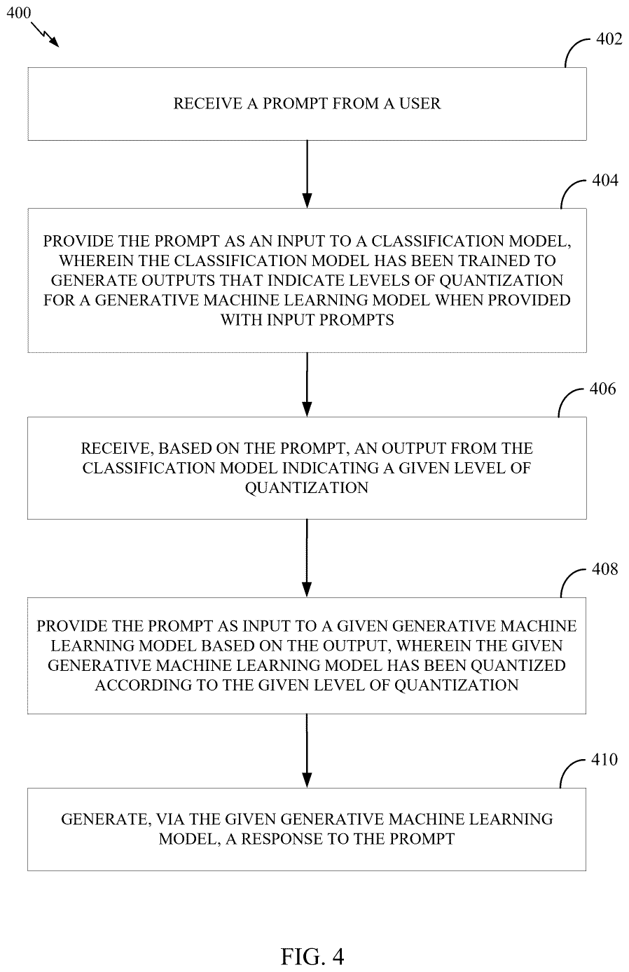

FIG. 4 depicts example operations 400 related to automated content generation. For example, operations 400 may be performed by one or more of the components described with respect to FIG. 1, FIG. 2, and FIG. 3.

Operations 400 begin at step 402 with receiving a prompt from a user.

Operations 400 continue at step 404 with providing the prompt as an input to a classification model, wherein the classification model has been trained to generate outputs that indicate levels of quantization for a generative machine learning model when provided with input prompts. In certain embodiments, the classification model is trained using training data that was created based on: providing a training prompt as input to a non-quantized generative machine learning model; receiving a particular output from the non-quantized generative machine learning model in response to the training prompt; providing the training prompt as input to two or more additional generative machine learning models, wherein each of the two or more additional generative machine learning models has a respective level of quantization; receiving a set of given outputs from the two or more additional generative machine learning models; and labeling the training prompt to indicate a highest level of quantization that resulted in a given output that matched the particular output. In some embodiments, the labeling is based on creating embedding representations of the given output and the particular output and comparing the embedding representations to determine whether the given output and the particular output match. In some embodiments, the classification model is trained through a supervised learning process comprising: providing the training prompt as input to the classification model; and iteratively adjusting parameters of the classification model based on a variance between a training output generated by the classification model and the label. According to certain embodiments, embedding representations of the prompt and the training prompt are generated, wherein the classification model generates the output based on a semantic similarity comparison involving the embedding representations. Certain embodiments provide that the labeling is based on using a text-based similarity algorithm to determine whether the given output and the particular output match.

Operations 400 continue at step 406 with receiving, based on the prompt, an output from the classification model indicating a given level of quantization. In certain embodiments, the given level of quantization comprises one of: int4; int8; float16; or none.

Operations 400 continue at step 408 with providing the prompt as input to a given generative machine learning model based on the output, wherein the given generative machine learning model has been quantized according to the given level of quantization.

Operations 400 continue at step 410 with generating, via the given generative machine learning model, a response to the prompt. Certain embodiments provide that user feedback is received regarding the response, wherein the classification model is retrained based on the user feedback. Some embodiments provide that retraining the classification model is based on labeling the prompt, wherein the label indicates a lower level of quantization than was indicated in the output received from the classification model. According to some embodiments, the response comprises an image.

### Example of a Processing System for Automated Content Generation

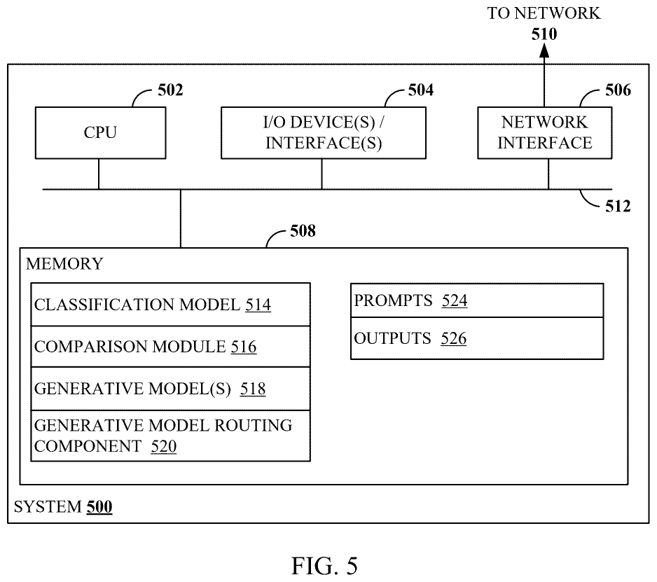

FIG. 5 illustrates an example system 500 with which embodiments of the present disclosure may be implemented. For example, system 500 may be configured to perform operations 400 of FIG. 4 and/or to implement one or more components as in FIG. 1, FIG. 2, or FIG. 3.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes classification model 514, comparison module 516, generative model(s) 518, and generative model routing component 520. Classification model 514 may be representative of classification model 200 of FIG. 2. In some embodiments, comparison module 516 may be representative of comparison module 300 of FIG. 3. Generative model(s) 518 may be representative of generative machine learning model(s) 130 of FIG. 1 and generative models 220A-D of FIG. 2 or FIG. 3. Generative model routing component 520 may be representative of generative model routing component 210 of FIG. 2.

Memory 508 further comprises prompts 524, which may correspond to prompt 202 of FIG. 2 or training prompt 302 of FIG. 3. Memory 508 further comprises outputs 526 which may correspond to output 230 of FIG. 2 or outputs 330A-D of FIG. 3.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automated content generation, comprising:
receiving a prompt from a user;
providing the prompt as an input to a classification model, wherein the classification model has been trained to generate outputs that indicate levels of quantization for a generative machine learning model when provided with input prompts;
receiving, based on the prompt, an output from the classification model indicating a given level of quantization;
providing the prompt as input to a given generative machine learning model based on the output, wherein the given generative machine learning model has been quantized according to the given level of quantization; and
generating, via the given generative machine learning model, a response to the prompt.

2. The method of claim 1, wherein the classification model is trained using training data that was created based on:
providing a training prompt as input to a non-quantized generative machine learning model;
receiving a particular output from the non-quantized generative machine learning model in response to the training prompt;
providing the training prompt as input to two or more additional generative machine learning models, wherein each of the two or more additional generative machine learning models has a respective level of quantization;
receiving a set of given outputs from the two or more additional generative machine learning models; and
labeling the training prompt to indicate a highest level of quantization that resulted in a given output that matched the particular output.

3. The method of claim 2, wherein the labeling is based on creating embedding representations of the given output and the particular output and comparing the embedding representations to determine whether the given output and the particular output match.

4. The method of claim 2, wherein the classification model is trained through a supervised learning process comprising:
providing the training prompt as input to the classification model; and
iteratively adjusting parameters of the classification model based on a variance between a training output generated by the classification model and the label.

5. The method of claim 2, wherein embedding representations of the prompt and the training prompt are generated, wherein the classification model generates the output based on a semantic similarity comparison involving the embedding representations.

6. The method of claim 2, wherein the labeling is based on using a text-based similarity algorithm to determine whether the given output and the particular output match.

7. The method of claim 1, wherein the given level of quantization comprises one of:
int4;
int8;
float16; or
none.

8. The method of claim 1, wherein user feedback is received regarding the response, wherein the classification model is retrained based on the user feedback.

9. The method of claim 8, wherein retraining the classification model is based on labeling the prompt, wherein the label indicates a lower level of quantization than was indicated in the output received from the classification model.

10. The method of claim 1, wherein the response comprises an image.

11. A system for automated content generation, comprising:
one or more processors; and
a memory comprising instructions that, when executed by the one or more processors, cause the system to:
receive a prompt from a user;
provide the prompt as an input to a classification model, wherein the classification model has been trained to generate outputs that indicate levels of quantization for a generative machine learning model when provided with input prompts;
receive, based on the prompt, an output from the classification model indicating a given level of quantization;
provide the prompt as input to a given generative machine learning model based on the output, wherein the given generative machine learning model has been quantized according to the given level of quantization; and
generate, via the given generative machine learning model, a response to the prompt.

12. The system of claim 11, wherein the classification model is trained using training data that was created based on:
providing a training prompt as input to a non-quantized generative machine learning model;
receiving a particular output from the non-quantized generative machine learning model in response to the training prompt;
providing the training prompt as input to two or more additional generative machine learning models, wherein each of the two or more additional generative machine learning models has a respective level of quantization;
receiving a set of given outputs from the two or more additional generative machine learning models; and
labeling the training prompt to indicate a highest level of quantization that resulted in a given output that matched the particular output.

13. The system of claim 12, wherein the labeling is based on creating embedding representations of the given output and the particular output and comparing the embedding representations to determine whether the given output and the particular output match.

14. The system of claim 12, wherein the classification model is trained through a supervised learning process comprising:
providing the training prompt as input to the classification model; and
iteratively adjusting parameters of the classification model based on a variance between a training output generated by the classification model and the label.

15. The system of claim 12, wherein embedding representations of the prompt and the training prompt are generated, wherein the classification model generates the output based on a semantic similarity comparison involving the embedding representations.

16. The system of claim 12, wherein the labeling is based on using a text-based similarity algorithm to determine whether the given output and the particular output match.

17. The system of claim 11, wherein the given level of quantization comprises one of:
int4;
int8;
float16; or
none.

18. The system of claim 11, wherein user feedback is received regarding the response, wherein the classification model is retrained based on the user feedback.

19. The system of claim 18, wherein retraining the classification model is based on labeling the prompt, wherein the label indicates a lower level of quantization than was indicated in the output received from the classification model.

20. A non-transitory computer-readable medium comprising instructions that, when executed by one or more processors of a computing system, cause the computing system to:
receive a prompt from a user;
provide the prompt as an input to a classification model, wherein the classification model has been trained to generate outputs that indicate levels of quantization for a generative machine learning model when provided with input prompts;
receive, based on the prompt, an output from the classification model indicating a given level of quantization;
provide the prompt as input to a given generative machine learning model based on the output, wherein the given generative machine learning model has been quantized according to the given level of quantization; and
generate, via the given generative machine learning model, a response to the prompt.
